(19) United States
(12) Patent Application Publication
(10) Pub. No.: US 2024/0082969 A1
(43) Pub. Date: Mar. 14, 2024

(54) HANDLING CELL FOR A MACHINE TOOL AND MANUFACTURING SYSTEM

(71) Applicant: CHIRON Group SE, Tuttlingen (DE)

(72) Inventors: Sebastian HUBER, Wurmlingen (DE); Dylan MARET, Martigny (CH); Markus KOHLER, Immendingen (DE)

(21) Appl. No.: 18/244,856

(22) Filed: Sep. 11, 2023

(30) Foreign Application Priority Data
Sep. 9, 2022 (DE) 10 2022 122 977.7

(51) Int. Cl. B23Q 7/04

(52) U.S. Cl. CPC B23Q 7/046; B23Q 7/048

(57) ABSTRACT

A handling cell for a machine tool comprises a loading interface, a handling unit with a handling robot, a feeding interface for a feeding cart, and a provisioning unit. The loading interface is arranged to be coupled to a workspace of a first machine tool. The feeding cart is used to transport workpieces that are arranged on loading aids. The provisioning unit moves loading aids between the feeding cart and a provisioning position for a transfer between the handling unit and the provisioning unit. A manufacturing system for machining comprises at least one machine tool, and a handling cell. The machine tool is configured for multi-axis machining and comprises a tool holder and a workpiece holder. The tool holder and the workpiece holder are movable relative to each other in at least three axes. The tool holder and the workpiece holder are mounted on a rear side of a workspace of the machine tool. The loading interface couples laterally to the workspace of the machine tool.

### CROSS-REFERENCES TO RELATED APPLICATIONS

This application claims priority to German patent application 10 2022 122 977.7, filed on Sep. 9, 2022. The entire content of this priority application is incorporated herein by reference.

### BACKGROUND

The present disclosure relates to a handling cell for a machine tool and to a manufacturing system comprising at least one machine tool and a handling cell. According to various aspects, the present disclosure relates to compact design machine tools and their integration into manufacturing systems and plants for machining. Compact design machine tools are, for example, those having a workspace smaller than 250 mm×250 mm×250 mm.

In exemplary embodiments, the workspace of the machine tool is smaller than 200 mm×200 mm×200 mm. In exemplary embodiments, the workspace of the machine tool is smaller than 150 mm×150 mm×150 mm. In exemplary embodiments, the workspace of the machine tool is smaller than 100 mm×100 mm×100 mm. In exemplary embodiments, the workspace of the machine tool is smaller than 75 mm×75 mm×75 mm. In certain embodiments, these parameters relate to the possible travel paths along the X, Y and Z axes. The workspace can be cube-shaped. However, cuboid-shaped spaces are also conceivable, whose travel paths are not uniform in X, Y and Z. By way of example, machine tools of that kind are suitable for precision machining, for example in the manufacture of watches, jewelry and the like. It goes without saying that other applications are also conceivable, for example in the field of medical technology, precision engineering and the like.

Machine tools and systems for metal-cutting manufacturing are known. US 2019/0084102 A1 discloses a manufacturing plant, which has a plurality of compact design machine tools that are arranged one above the other and side by side, which are arranged in a common enclosure, wherein in addition a robot is provided for the tool change and/or workpiece change, which is arranged to be horizontally movable on a vertically movable beam. The system includes an integrated storage for workpieces that can be moved with the robot.

EP 2 227 349 B1 discloses a movable robot cell having a housing, which robot cell can be placed in front of an opening to a workspace of a machine tool, if required, in order to load workpieces with a robot. In the operational state, the robot cell blocks an access opening of the machine tool that is usually provided for a worker.

A processing system for workpieces is known from EP 2 036 664 A1, having at least one processing machine, a guarding enclosure having at least one rack magazine, and a loading device that is arranged inside the guarding enclosure for loading and unloading the processing machine, wherein the loading device comprises a carriage, which is displaceable along a guide and has an adjustable extension arm, which carries at least one handling unit for parts to be handled, wherein the guide for the carriage is provided in an overhead region, and wherein the extension arm, which is articulated on the underside of the carriage, of the loading device has two arms which are coupled together and which are pivotable relative to one another. The at least one rack magazine is part of the guarding enclosure.

DE 35 43 209 A1 discloses a manufacturing system for the flexible production of workpieces, which comprises several machine tools, a transport system for workpieces that connects the machine tools, and a loading device for each machine tool, which is arranged between the machine tool and the transport system and is configured for loading and unloading the machine tool. The manufacturing system includes a loading station and an unloading station spaced apart from each other. Buffer storage is required there in each case.

DE 10 2014 114 258 A1 discloses an arrangement comprising a singlestation metal cutting machine and a robot cell, wherein the robot cell can be coupled to the cutting machine for loading and unloading the latter, wherein the cutting machine has a machine room and the robot cell has a robot cell room, and wherein, in the coupled state of the robot cell, the machine room and the robot cell room form a common machining room. Buffer storage is arranged within the robot cell. In the operational state, the robot cell blocks an access opening of the machine tool that is normally provided for a worker.

By way of example, it has been observed that the desired components can be manufactured with high precision and efficiency using a compact design machine tool, even with relatively small external dimensions of the machine tool.

However, it has also been observed that specific constraints have to be taken into account with regard to automation aspects for compact design machine tools. On the one hand, transfer systems, handling units and the like cannot be designed to be arbitrarily compact. Even if this were possible from a technological point of view, in practice there are often certain minimum dimensions for transfer systems, handling units, robots, grippers and the like.

This may result in the actual machine tool (and its workspace, respectively) being small in relation to the automation technology (handling technology, transfer systems and the like).

Furthermore, the automation technology (for example, robots with grippers and the like) must interact with the machine tool in the installation space (if applicable, workspace) of the machine tool to enable the transfer of workpieces and, if applicable, tools.

Furthermore, it has been observed that even with compact design machine tools, there is often a desire for the possibility of direct visual monitoring by the operator. Similar to machine tools of larger design, access openings (doors) with windows are regularly demanded. In an automated system, this means that this area (“front” of the machine tool) is not available for automation technology.

Furthermore, it has been observed that compact design machine tools are often designed small in relation to commercially available automation technology. This results in specific requirements for the automation of compact design machine tools. Furthermore, new possibilities for automation and interlinking arise that may not have been feasible with conventional machine tools.

In view of this, it is an object of the present disclosure to present a handling cell for a machine tool that is suitable for compact machine tools.

It is a further object of the present disclosure to present a handling cell that should take into account specific boundary conditions for compact design machine tools.

It is a further object of the present disclosure to present a handling cell by means of which it should be possible to implement manufacturing systems that enable partially automated or even highly automated production even with only a small installation space. This relates, for example, to the workpiece change.

It is a further object of the present disclosure to present a manufacturing system comprising a handling cell and at least one machine tool, wherein the machine tool can be automatically loaded and unloaded via the handling cell for workpiece changing purposes.

### SUMMARY

According to a first aspect, these and other objects are achieved by a tool changing device handling cell for a machine tool, comprising:
a loading interface that is arranged to be coupled to a workspace of a machine tool,
a handling unit with a handling robot,
a feeding interface for a feeding cart, and
a provisioning unit that is interposed between the handling unit and the feeding interface,
wherein the feeding cart is configured to transport workpieces that are arranged on loading aids, and
wherein the provisioning unit is configured to move the loading aids with the workpieces between the feeding cart and a provisioning position, where a transfer of workpieces between the provisioning unit and the handling unit takes place.

According to another aspect, these and other objects are achieved by a manufacturing system for machining workpieces, comprising:
at least one machine tool which is configured for multi-axis machining and has a tool holder and a workpiece holder, which are movable relative to one another in at least three axes,
wherein the tool holder and the workpiece holder are mounted on a rear side of a workspace of the machine tool, and
a handling cell, comprising:
a loading interface that is arranged to be coupled to a workspace of a first machine tool,
a handling unit with a handling robot,
a feeding interface for a feeding cart, and
a provisioning unit that is interposed between the handling unit and the feeding interface,
wherein the feeding cart is configured to transport workpieces that are arranged on loading aids, and
wherein the provisioning unit is configured to move the loading aids with the workpieces between the feeding cart and a provisioning position, where a transfer of workpieces between the provisioning unit and the handling unit takes place,
wherein the loading interface is laterally coupled to the workspace of the machine tool.

According to another aspect, the present disclosure relates to a handling cell for a machine tool comprising:
a first loading interface that is arranged to be coupled to a workspace of a first machine tool,
a handling unit with a handling robot,
a feeding interface for a feeding cart, which is used to transport workpieces that are arranged on loading aids, in particular on trays, and
a provisioning unit that moves loading aids between the feeding cart and a provisioning position for transfer between the handling unit and the provisioning unit.

In this way, a machine tool can be upgraded for an automated workpiece change. The handling cell is suitable at least in exemplary embodiments for compact design machine tools.

The loading aid is, for example, a pallet, a tray or a box for holding a plurality or even a large number of workpieces. The workpieces are, for example, precision mechanical workpieces, components for watches, components for medical technology and the like. In an exemplary embodiment, the loading aid is configured to hold both unmachined workpieces (blanks) and machined workpieces. However, it is also conceivable to use a first type of loading aids for providing unmachined workpieces and a second type of loading aids for receiving machined workpieces.

For example, workpieces with only small dimensions can be machined using machine tools with a correspondingly small workspace. This has an overall positive effect on the installation space requirement (footprint). However, if machine tools with only small dimensions and e.g., small installation spaces are used, one may aim at the handling unit with the handling robot interacting as little as possible with the installation space.

This may relate to arrangements in which the handling robot moves into the installation space of the machine tool only for the purpose of changing the workpiece. If no workpiece change is being performed, the handling robot is completely moved out of the workspace according to these arrangements.

In an exemplary embodiment, the first loading interface can be closed by a door so that the workspace is sufficiently separated from the handling cell when no workpiece change takes place.

According to an exemplary embodiment, the handling robot is configured to enter the workspace of the machine tool through the first loading interface with at least one workpiece gripper in order to transfer a workpiece directly to or from a workpiece holder.

The handling robot with the workpiece gripper can move far enough into the workspace to exchange workpieces there. This includes, for example, a transfer of workpieces to be processed to a workpiece holder and a transfer of processed workpieces from the workpiece holder. Since the handling robot is not installed in the workspace, the workspace is not occupied by the handling robot if no workpiece change takes place and the handling robot with the workpiece gripper is moved out of the workspace.

According to another exemplary embodiment, the handling robot is a suspended robot, for instance a suspended articulated robot. In this way, the handling robot is suspended inside the handling cell so that an area below the handling robot is basically available as installation space for installations. This can simplify loading of the handling cell with the feeding cart. The feeding cart is arranged, for example, as a floor conveyor. The feeding cart can therefore be placed underneath the handling robot in exemplary embodiments, at least when the handling robot is in a retracted state.

According to another arrangement, the handling robot has a multiple gripper for workpieces. The multiple gripper is arranged, for example, as a double gripper, triple gripper or quadruple gripper. With a multiple gripper, the workpiece change can be accelerated. The handling robot can pick up a processed workpiece in the workspace and deliver a workpiece (blank) to be processed without having to be moved out of the workspace in the meantime. The same applies to the change of workpieces at the loading aid in the provisioning position.

According to a further arrangement, the handling cell further comprises a second loading interface that is facing away from the first loading interface, which can be coupled to a workspace of a second machine tool.

In this way, the handling cell can be used to supply two machine tools. Even with the second machine tool, the workspace is not excessively stressed if no workpiece change is performed.

According to a further arrangement, the handling robot is movable along a positioning axis, for instance a horizontally oriented and/or ceiling side positioning axis, between the first loading interface and the second loading interface, wherein the provisioning position is arranged along the travel path of the handling robot along the positioning axis between the first loading interface and the second loading interface.

In this way, the handling robot can control both a first machine tool at the first loading interface and a second machine tool at the second loading interface. Further degrees of freedom of movement of the handling robot allow the handling robot with the workpiece gripper to be moved into the respective workspace.

According to another arrangement, the handling robot is guided along the positioning axis between the first loading interface and the second loading interface over the feeding cart during the travel movement.

In this way, the space under the handling robot (and under or next to the positioning axis, respectively) can be used for feeding purposes. The handling cell can have a considerable capacity for holding workpieces due to the feeding cart. In this way, the two machine tools can be automated and operated autonomously at least temporarily. This includes, by way of example, both the provision of unmachined workpieces (blanks) and the pickup of machined workpieces of a series of workpieces. The feeding cart can feed a plurality of blanks into the handling cell and, after machining, be moved out of the handling cell with a corresponding number of machined workpieces.

According to another arrangement, the handling cell further comprises a bay for the feeding cart that is integrated in an enclosure of the handling cell, wherein in the entered state of the feeding cart a transfer of loading aids between the feeding cart and the provisioning position is enabled.

The provisioning unit can directly approach the feeding cart that is positioned at the bay to move loading aids and workpieces placed on them between the feeding cart and the provisioning position.

In an exemplary embodiment, the feeding cart can completely enter the handling cell. This also includes, for example, a barrier to the outside, such as a door, when the feeding cart entered and is positioned at the bay.

According to a further arrangement, the feeding cart has a movable securing element for securing received loading aids, wherein the securing element is mechanically unlocked when the feeding cart is moved into the handling cell.

The movable securing element is configured as a securing bar, for instance. The securing bar extends over several or all receiving spaces for loading aids in the feeding cart. In an exemplary embodiment, the securing bar has a roller that is lifted on a ramp when the feeding cart is moved into the handling cell. In this way, the securing bar is also lifted. The securing bar further comprises a deflector that at least partially deflects the lifting movement into a horizontal movement during lifting. In this way, the receiving spaces can be released when the securing element moves out laterally.

According to another arrangement, the provisioning unit has a vertically oriented lifting axis and a horizontally oriented transfer axis with a support for at least one loading aid.

In this way, a loading aid can be removed from the feeding cart and made available for the transfer of workpieces with the handling robot at the provisioning position. For example, a footprint within the handling cell used for transferring the loading aids between the feeding cart and the provisioning position is only slightly larger than twice the footprint of the feeding cart. This also contributes to the compactness of the handling cell and the production system as a whole.

In an exemplary embodiment, the transfer axis is oriented perpendicular to an entry direction for the feeding cart. This allows loading aids to be removed laterally from the feeding cart within the handling cell. This allows a small footprint.

According to a further arrangement, the transfer axis is arranged on a lifting carriage which is movable along the lifting axis, wherein the transfer axis comprises a linear drive to enter the feeding cart and to remove loading aids from one or more receiving spaces of the feeding cart or to deposit them there.

This means that the movements required for transferring loading aids can be generated with just a few driven axes. The feeding cart itself does not have to be equipped with active (motor-driven) handling technology.

In an exemplary embodiment, the transfer axis is parallel to the positioning axis of the handling robot. In this way, the installation space in the handling cell is used efficiently.

According to a further arrangement, the lifting axis is adapted to generate lifting movements or depositing movements when the support entered the feeding cart along the transfer axis in order to selectively lift or deposit loading aids from receiving spaces.

In an exemplary embodiment, the handling cell comprises a control device that is configured to control at least one of the provisioning unit, the lifting axis and the transfer axis accordingly. In an exemplary embodiment, the handling cell comprises a control device that is configured to control the provisioning unit, the lifting axis and the transfer axis accordingly. The control device can be part of a higher-level control device of the manufacturing system.

According to another arrangement, the provisioning unit further comprises a tilting mechanism that tilts loading aids, if required, to create a preferred orientation for workpieces in the loading aid. In this way, a loading aid can be tilted at the provisioning position. For example, the tilting mechanism is arranged at the support of the transfer axis. Arrangements are also conceivable in which such tilting is not required.

Tilting of the loading aid causes workpieces to slide within their respective locating seat in a defined direction, for example in the direction towards a stop. This increases the overall accuracy. For the handling robot, gripping workpieces is simplified.

According to a further arrangement, the tilting mechanism has a tilting axis, a holding piece fixed to the frame and spaced from the tilting axis, and a bearing piece that can be engaged in the holding piece, wherein a tilting of the loading aid is possible with the bearing piece engaged in a lifting movement along the lifting axis. The holding piece can hold the bearing piece (for instance in the vertical lifting direction) so that a further lifting movement of the lifting carriages is followed by a tilting about the tilting axis. In this way, the tilting movement can be generated without the need for a separate tilting drive. By way of example, the support for the at least one loading aid is pivotably mounted on the lifting carriage. A non-tilted position is assumed automatically by gravity.

According to another arrangement, a change of the feeding cart is enabled while a loading aid is available at the provisioning position for the transfer of workpieces. This can be achieved, for example, by the provisioning unit providing a loading aid at the provisioning position and not interacting with the feeding cart during this time. Then, at least one buffer (e.g., a loading aid for holding a plurality of workpieces) is provided for a plurality of workpieces at the provisioning position. This ensures a certain time window in which a feeding cart can be exchanged. This allows a series of workpieces to be processed without interruption.

According to another aspect, there is presented a manufacturing system for machining, for instance for manufacturing precision mechanical workpieces, comprising:
at least one machine tool, for instance a compact design machine tool, which is arranged for multi-axis machining and has a tool holder and a workpiece holder which can be moved relative to one another in at least three axes,
wherein the tool holder and the workpiece holder are mounted on a rear side of a workspace of the machine tool, and
a handling cell according to at least one of the arrangements described herein, wherein the loading interface couples laterally to the workspace of the machine tool.

In this way, the machine tool can be operated at least partially automatically. This includes, for example, the production of series, wherein workpieces can be changed semi-automatically or fully automatically.

The front of the workspace is therefore free and accessible for an operator, at least in exemplary embodiments. The front side can also be referred to as the operator side. The front side is arranged opposite the rear side. Lateral sides of the workspace are available for handling (workpiece change, tool change). In this way, the compact design is taken into account.

The handling cell is adjacent to the workspace of the machine tool, for example arranged at a small distance laterally thereto. The handling unit is assigned to the handling cell and not to the machine tool. This means that the machine tool, which has only a relatively small workspace, does not require any complex interventions or adjustments.

The handling unit can approach the workpiece holder and any holding device already located there in order to carry out a workpiece change (loading and unloading) in the workspace. This can also involve the removal of residual pieces (waste).

In an exemplary embodiment, the tool holder is configured as a tool spindle and is provided with a vertically oriented axis. The workpiece holder is assigned to a swivel axis and/or a swivel table of the machine tool, for example.

According to an exemplary embodiment, the manufacturing system further comprises:
at least one further machine tool, for instance a compact design machine tool, which is arranged for multi-axis machining and has a tool holder and a workpiece holder which can be moved relative to one another in at least three axes, wherein the tool holder and the workpiece holder are mounted on a rear side of a workspace of the machine tool,
wherein the handling cell has a second loading interface facing away from the first loading interface,
wherein the first loading interface is laterally coupled to the workspace of the first machine tool, and
wherein the second loading interface is laterally coupled to the workspace of the second machine tool.

In this way, two machine tools can be automated or at least partially automated with only one handling cell. This relates for instance to the workpiece change.

According to a further exemplary embodiment, the first machine tool and the second machine tool each have a loading side that is defined with respect to the workspace, which loading side is arranged equally for the first machine tool and the second machine tool with respect to the respective workspace, wherein the first machine tool and the second machine tool are arranged opposite one another and offset from one another by 180° about an imaginary vertical center axis and coupled to the handling cell.

This may have the result that the handling cell can be arranged between two essentially similar or even identical machine tools in which the same side of the workspace (in relation to their workspaces and tool spindle) serves as the loading side. In other words, from the operator's point of view, the operator side of the first machine tool and the operator side of the second machine tool are oriented in opposite directions. For example, the respective side of the machine tools that is facing away from the handling cell is a setup side (tool change side).

It is to be understood that the previously mentioned features and those mentioned in the following may not only be used in the respectively indicated combination, but also in other combinations or as isolated features without leaving the spirit and scope of the present disclosure.

### BRIEF DESCRIPTION OF THE DRAWINGS

Further features and advantages of the present disclosure will be apparent from the following description and explanation of several exemplary embodiments with reference to the drawings, wherein:

FIG. 1: is a perspective view of a machine tool;

FIG. 2: is a perspective view of a manufacturing system with a machine tool and a handling cell that is coupled thereto;

FIG. 3: is a schematic top view of a manufacturing system having a handling cell arranged between a first machine tool and a second machine tool for loading both machine tools with workpieces;

FIG. 4: is a perspective view of a handling cell with an open door, where a feeding cart is inserted into the handling cell;

FIG. 5: is a detailed view of the arrangement according to FIG. 4;

FIG. 6: is a side view of a provisioning unit that cooperates with a feeding cart;

FIG. 7: is a partial perspective view of a provisioning unit that has removed a loading aid from a feeding cart and placed it in a provisioning position;

FIG. 8: is a partial side view illustrating the transfer of loading aids within the handling cell between a feeding cart and a handling unit with handling robot;

FIG. 9: is a partial perspective view of a loading aid support that is associated with the provisioning unit to illustrate a tilt function; and

FIG. 10: is a partial perspective view of a handling unit with a handling robot illustrating a workpiece gripper.

### EMBODIMENTS

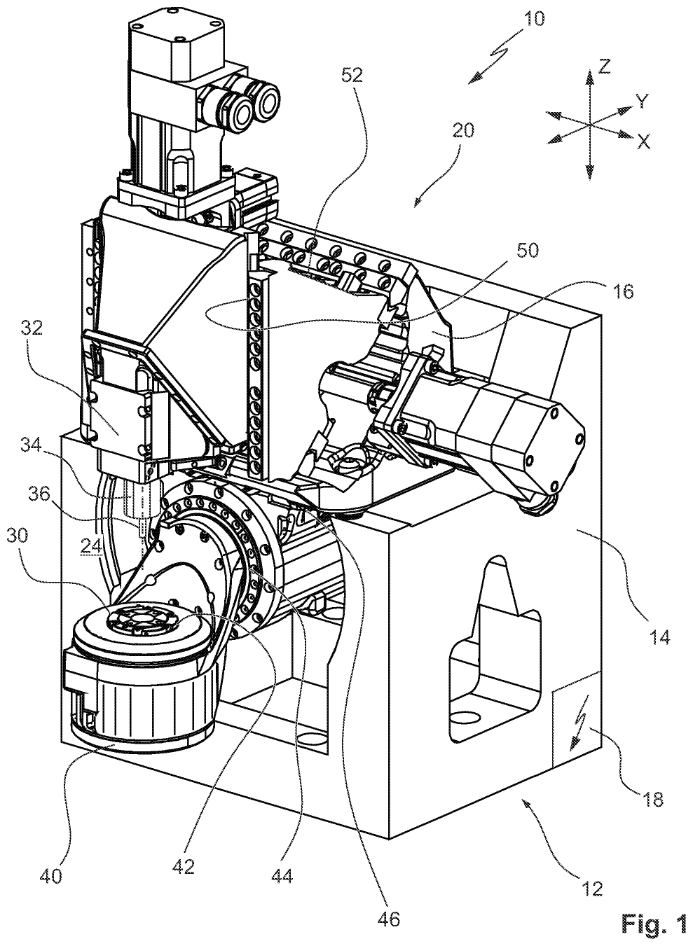

FIG. 1 illustrates by means of a perspective view an exemplary embodiment of a compact design machine tool 10 that is suitable for manufacturing precision mechanical components. The machine tool 10 comprises a frame 12, which in the exemplary embodiment comprises a base frame 14, on which a frame block 16 is mounted. Significant forces generated during machining are absorbed by the frame block 16. The base frame 14 serves as a support for the frame block 16. In FIG. 1, a control device of the machine tool 10 is further indicated by 18. The control device 18 controls components and functions of the machine tool 10 to machine workpieces in the desired manner. Control via external devices is also conceivable.

The machine tool 10 further comprises kinematics 20 configured as a multi-axis kinematics. In at least some of the Figures, a Cartesian coordinate system X-Y-Z is shown for illustrative purposes. The X-Y-Z coordinate system includes an X-axis (lateral direction), a Y-axis (depth direction), and a Z-direction (height direction). The X-axis and the Y-axis are horizontal axes in the exemplary embodiment. The Z-axis is a vertical axis in the exemplary embodiment. The X-Y-Z axes are orthogonal to each other. The X-Y-Z coordinate system is primarily used to illustrate and describe components and functions of the machine tool 10. It is understood that other coordinate systems may also be used for these purposes. The coordinate system X-Y-Z is therefore not to be understood in a limiting sense. The person skilled in the art can carry out the necessary conceptual steps for the conversion into other coordinate systems without further ado.

In the exemplary embodiment, the kinematics 20 comprise various components which are mounted indirectly or directly on the frame block 16. This ensures short force paths and high stiffness. In FIG. 1, further a workspace is indicated by 24, in which machining with the machine tool 10 takes place.

The machine tool 10 further comprises a workpiece holder 30 (also: workpiece receptacle) for holding at least one workpiece to be machined. Furthermore, a tool spindle 32 is provided. The tool spindle 32 comprises a tool holder 34 configured to receive a tool 36. The tool 36 is rotatably drivable to machine a workpiece held by the workpiece holder 30.

In the exemplary embodiment, the workpiece holder 30 sits on a cantilever arm 40 that is guided on one side, which accommodates a pivot drive or rotary drive 42 for the workpiece holder 30. The rotational axis provided in this manner may also be referred to as the C-axis. The cantilever arm 40 is coupled to a linear drive 46 via another rotary drive 44, which in turn is mounted to the frame block 16. The rotary drive 44 provides a rotational axis, which may be referred to as the B-axis. The linear drive 46 provides a translational axis, which may be referred to as the Y-axis.

The tool spindle 32 is coupled to the frame block 16 via a linear drive 50 and a linear drive 52. The linear drive 50 provides a translational axis, which may also be referred to as the Z-axis. The linear drive 52 provides a translational axis, which may also be referred to as an X-axis. The two linear drives 50, 52 form a cross-slide drive. In the exemplary embodiment, two translational axes (X, Z) are associated with the tool spindle 32 and the tool 36, respectively. A translatory axis (Y) is assigned to the tool changer 30 and the workpiece, respectively. Furthermore, in the exemplary embodiment two rotatory axes/swivel axes (B, C) are assigned to the workpiece holder 30 and the workpiece, respectively. Other types of assignment are conceivable and depend on the machine kinematics concept.

Overall, the machine tool 10 provides a compact workspace 24. This in turn leads to a small size of the machine tool 10, combined with low weight and low energy requirements. At the same time, high precision and a high material removal rate can be ensured due to the design-specific rigidity. The workspace 24 is easily accessible, since the workpiece holder 30 and the tool holder 34 are each arranged and mounted on a rear side of the workspace 24 indirectly or directly on the frame block 16 and on the base frame 14 of the frame 12. Thus, basically three sides (front side as well as two lateral sides) are available for horizontal access to the workspace 24.

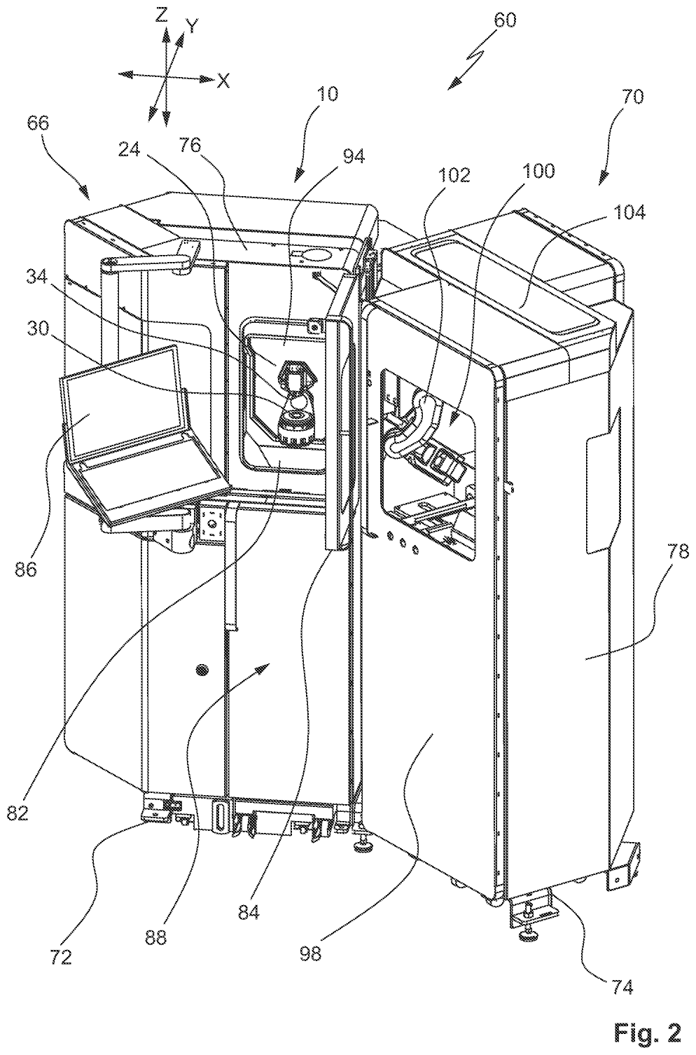

FIG. 2 illustrates, by means of a perspective view, an arrangement of a manufacturing system 60. The manufacturing system 60 comprises a machine tool 10 that is configured according to the arrangement shown in FIG. 1 in the exemplary embodiment. Further, a handling cell 70 is provided that is laterally coupled to the machine tool 10 and its workspace 24, respectively. In the exemplary embodiment, lateral means that the coupling is neither at a rear side nor at a front side.

In the exemplary embodiment shown in FIG. 2, the manufacturing system 60 further comprises a setup cell 66 that is also laterally coupled to the workspace 24 of the machine tool 10. By way of example, the machine tool 10 is arranged between the setup cell 66 and the handling cell 70. The machine tool 10 stands on a base frame 72, which is supported on the ground side in the exemplary embodiment. The workspace 24 and other components of the machine tool 10 can be enclosed by an enclosure 76. In the exemplary embodiment, the enclosure 76 also accommodates the setup cell 66. This is not to be understood in a limiting sense.

The workpiece holder 30 and the tool holder 34 are disposed in the workspace 24 and arranged on a rear side 94 of the workspace 24. This provides good accessibility from a front side which is opposite the rear side 94, and which is referred to as the operator side 88. The workspace 24 is accessible via an access opening 82. At the operator side 88, the workspace 24 is easily visible. In the exemplary embodiment, a door 84 is provided to close the access opening 82, if required. An exemplary embodiment of the door 84 is a swinging door. It is also conceivable to arranged the door 84 as a sliding door, for instance as a vertically movable sliding door that is moved upward to uncover the access opening 82.

FIG. 2 further shows an operator console 86 facing an operator standing at the operator side 88. The operator console 86 interacts with the control device 18 (compare FIG. 1). The operator console 86 serves to control and monitor the machine tool 10. In exemplary embodiments, the operator console 86 also serves to control and monitor the handling cell 70 and/or the setup cell 66.

The handling cell 70 has a cabinet-like design. The handling cell 70 enables an automated workpiece change. In exemplary embodiments, the handling cell 70 also serves for at least temporary storage of workpieces (blanks and/or machined workpieces). The handling cell 70 rests on a frame 74 and comprises an enclosure 78. In the exemplary embodiment, a door 98 is provided through which an interior of the handling cell 70 is accessible.

FIG. 2 further indicates a handling unit 100 of the handling cell 70 comprising a handling robot 102. The handling robot 102 is a suspended robot in the exemplary embodiment and is, for example, ceiling side (top) mounted, compare a ceiling side designated 104 in FIG. 2.

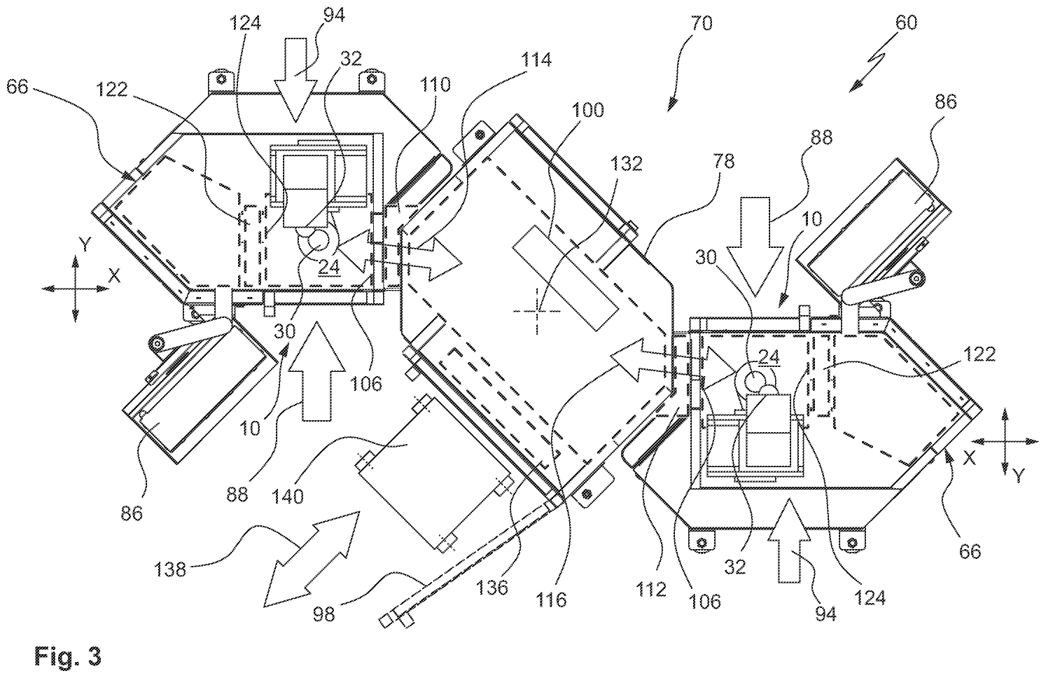

Based on FIG. 2, FIG. 3 illustrates a schematic top view of a manufacturing system 60. The exemplary embodiment according to FIG. 3 differs from the embodiment according to FIG. 2 in that FIG. 3 provides a handling cell 70 arranged between a first machine tool 10 and a second machine tool 10. The machine tools 10 have the same design in the exemplary embodiment. Each of the two machine tools 10 includes a workspace 24 with workpiece holder 30 and tool spindle 32. The orientation of each of the machine tools 10 is illustrated by an X-Y (machine) coordinate system. The Z-axis is perpendicular to the respective view plane.

The handling cell 70 is provided with a handling unit 100 that is illustrated merely by a block in FIG. 3. The handling cell 70 has a first loading interface 110 in the direction towards the first machine tool 10 and a second loading interface 112 in the direction towards the second machine tool 10. An arrow 114 illustrates a loading process through the first loading interface 110. An arrow 116 illustrates a loading process through the second loading interface 112. The handling cell 70 is configured to engage the workspace 24 of the machine tools 10 only during actual workpiece changes. If no workpiece change takes place, for example during machining of a workpiece picked up at the workpiece holder 30, there is no intervention of the handling cell 70 in the respective workspace.

The machine tools 10 each include a rear side 94 on which the workpiece holder 30 and the tool spindle 32 are indirectly or directly mounted. Opposite the rear side 94, an operator side 88 is provided, via which an operator can view the workspace 24 and/or access to the workspace 24 is enabled.

A first side of the workspace 24 of the machine tools 10 serves as the loading side 106. There, the loading interface 110, 112 is coupled to the workspace 24. A side facing away from the loading side 106 serves as the setup side 124 There, the setup cell 66 is coupled via a respective setup interface 122. The setup interface 122 may also be referred to as the tool change interface. In both machine tools 10 shown in the exemplary embodiment according to FIG. 3, when the workspace 24 is viewed via the front/operator side 88, the loading side 106 is provided on the same side of the workspace 24. In FIG. 3, the two machine tools 10 are spaced apart and offset relative to each other by 180° with respect to an (imaginary) vertical center axis 132.

In this way, one and the same handling cell 70 can be used to load two similar machine tools 10. On the one hand, this results in a compact design of the manufacturing system 60 and, on the other hand, good accessibility via the respective operator side 88 of the machine tools 10. In this regard, also compare the exemplary embodiment of the respective operator console 86 adjacent to the operator side 88 of the machine tools 10 in the top view according to FIG. 3.

In the exemplary embodiment shown in FIG. 3, the door 98 of the enclosure 78 of the handling cell 70 is open. The handling cell 70 has a feeding interface 136 via which a feeding cart 140 can enter an interior space within the enclosure 78 along an entry direction 138. When the feeding cart 140 entered the enclosure 78, the door 98 can be closed. Thus, the feeding interface 136 is usually not used to transfer single workpieces or single loading aids individually.

Instead, the feeding interface 136 serves to move in and out the feeding cart 140, which may contain a plurality of loading aids and possibly a plurality of workpieces. In this way, the handling cell 70 can also serve as a storage or buffer. This enables highly automated and at least temporarily autonomous operation of the manufacturing system 60. In the exemplary embodiment, the feeding cart 140 serves to receive unmachined workpieces (blanks) as well as machined workpieces (finished parts). This is not to be understood in a limiting sense.

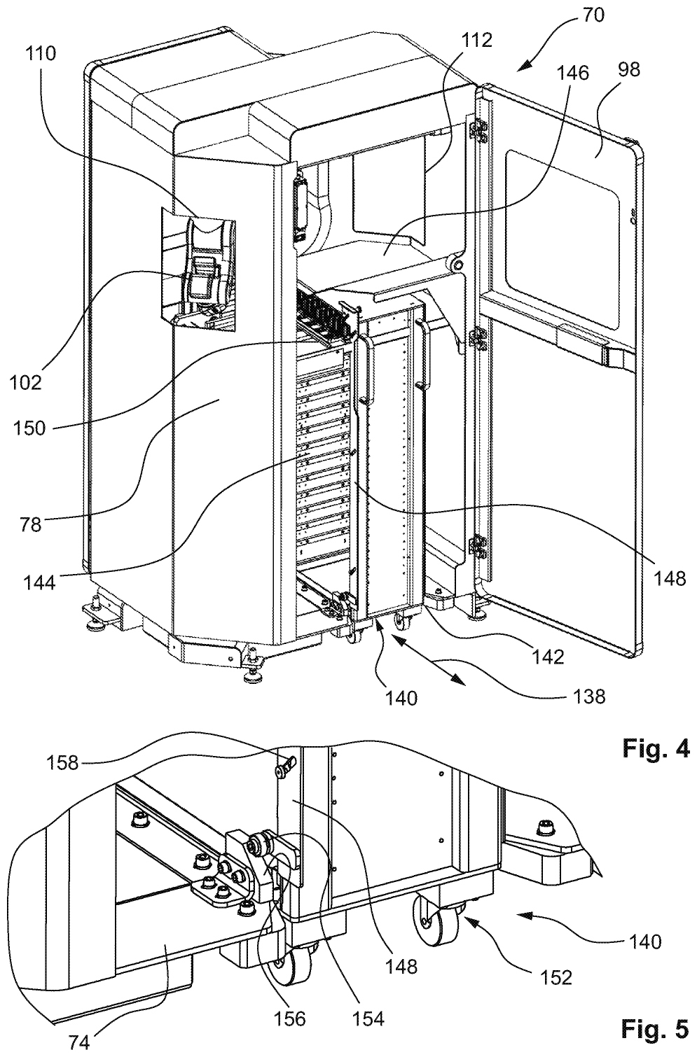

FIG. 4 illustrates, by means of a perspective view, a state of the handling cell 70 in which the feeding cart 140 is retracted into a bay 142 within the enclosure 78. In this state, the door 98 can be closed so that the feeding cart 140 is fully accommodated by the enclosure 78. This allows safe and low error operation of the handling cell 70. Possible handling operations are protected by the enclosure 78. Further the handling robot 102 is shown in FIG. 4 (in part), which can be guided, if required, through the first loading interface 110 and/or the second loading interface 112 toward a workspace 24 of a machine tool 10 to perform a workpiece change.

The feeding cart 140 includes a plurality of receiving spaces 144 configured as slide-in modules in the exemplary embodiment. For example, five or more receiving spaces 144 are provided, arranged one above the other. The receiving spaces 144 serve to accommodate loading aids 150. Trays, for example, can serve as loading aids 150. The use of so-called Euro boxes or similar loading aids is also conceivable. It is essential that the loading aids 150 can be inserted into the receiving spaces 144. In the exemplary embodiment, a transfer direction of the loading aids 150 is approximately perpendicular to the entry direction 138 of the feeding cart 140.

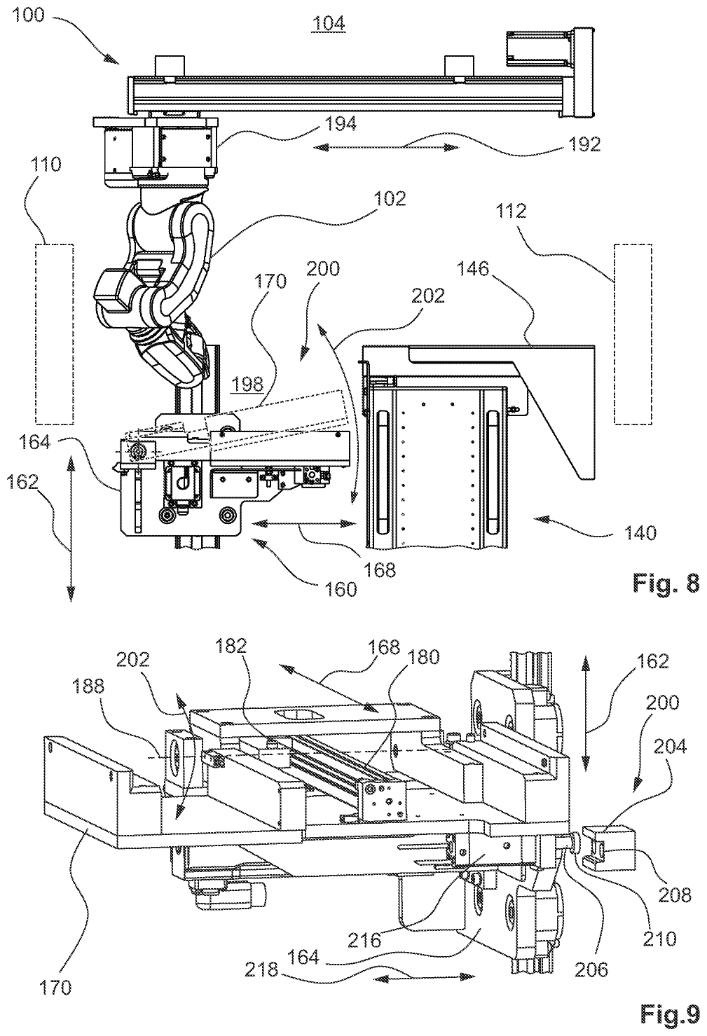

In the exemplary embodiment according to FIG. 4, there is further provided a cover 146 for shielding a movement space that is used by the ceiling side arranged handling robot 102 downward. The feeding cart 140 is positioned in the bay 142 below the cover 146 (compare also FIG. 8) and is protected by it.

A securing element 148, which in the exemplary embodiment is arranged as a securing bar, is used to secure loading aids 150 in the receiving spaces 144 of the feeding cart 140. FIG. 5 illustrates a mechanical deactivation (and activation) of the securing element 148 during insertion (and removal) of the feeding cart 140. The feeding cart 140 has a chassis 152. The feeding cart 140 is rollable, and entry into the bay 142 is enabled in the entry direction 138. At least one roller 154 is arranged on the securing element 148, which contacts a ramp 156 that is connected to the frame 74 of the handling cell 70 when the feeding cart 140 enters. When the feeding cart 140 enters, the roller 154 is raised by the (fixed) ramp 156, which also raises the securing element 148.

The securing element 148 is movably arranged on the feeding cart 140 via an inclined deflection 158. In this way, the lifting movement is at least partially deflected into a horizontal movement (in the exemplary embodiment parallel to the retraction direction 138) when the roll 154 is lifted. This allows lateral disengagement of the securing element 148 so that loading aids 150 can be removed from the receiving spaces 144. Once the feeding cart 140 has moved out of the bay 142, the securing element 148 is reengaged. Outside the bay 142 in the handling cell 70, the loading aids 150 are adequately secured in their position in the receiving spaces 144 of the feeding cart 140.

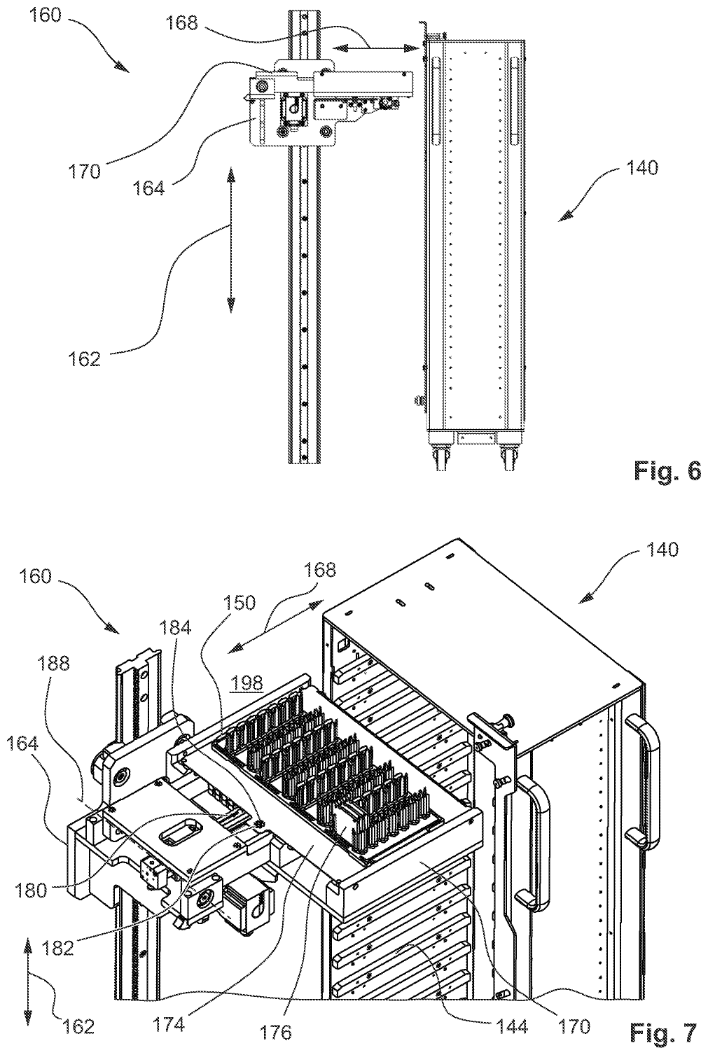

FIG. 6 illustrates, by means of a lateral view (the view orientation corresponds to the entry direction 138), a provisioning unit 160 that is used to transfer loading aids 150 with workpieces between the feeding cart 140 and the handling unit 100. The provisioning unit 160 is arranged to position loading aids 150 in a provisioning position 198 (shown in FIGS. 7 and 8) in which the loading aids are accessible for the handling unit 100. The provisioning unit 160 and its interaction with the feeding cart 140 is further illustrated by a partial perspective view in FIG. 7. Also compare the illustrations in FIG. 8 and FIG. 9.

In the exemplary embodiment, the provisioning unit 160 has a lifting axis 162 and a transfer axis 168. The lifting axis 162 is oriented vertically. The transfer axis 168 is oriented horizontally. The transfer axis 168 is oriented approximately perpendicular to the entry direction 138 for the feeding cart 140.

The lifting axis 162 comprises a vertically movable lifting carriage 164, which is coupled to a lifting drive and carries components of the transfer axis 168. The transfer axis 168 comprises a horizontally movable support 170, which is used to hold loading aids 150. Via movement along the lifting axis 162, the support 170 can approach a selected receiving space 144 in the feeding cart 140. Via the transfer axis 168, the support 170 can move into or out of the feeding cart 140 to transfer loading aids 150.

In the exemplary embodiment according to FIG. 7, a tray 174 serves as loading aid 150. Other types of loading aids are conceivable. The loading aid 150 serves to receive workpieces 176, which are positioned there in suitable receptacles. A pick-up of a loading aid 150 from a receiving space 144 or a deposit of the loading aid 150 in/on a receiving space 144 of the feeding cart 140 typically comprises a positioning of the support 140 along the transfer axis 168 and a lifting movement (small in amount) along the lifting axis 162 for lifting or lowering within the feeding cart 140. When the support 170 with the loading aid 150 is extended from the feeding cart 140, a lifting movement (usually larger in amount) takes place along the lifting axis 162 to position the loading aid 150 in the provisioning position 198. The necessary control of the lifting axis 162 and the transfer axis 168 is performed via the control device 18 (compare FIG. 1) or another control device of the handling cell 70 and/or of the manufacturing system 60.

The transfer axis 168 comprises a linear drive 180, exemplarily comprising a cylinder. In the exemplary embodiment according to FIG. 7, a positive drive of the loading aid 150 is also shown. For this purpose, a driving pin 182 is provided which can engage in a driving recess 184. Compare also the illustration in FIG. 9 regarding the driving pin 182 and the linear drive 180. In an exemplary embodiment, the driving recess 184 is tapered, for example V-shaped, in the direction towards the lifting carriage 164, so that centering results when the driving pin 182 pulls the loading aid 150 out of the feeding cart 140 via the driving recess 184.

In the exemplary embodiment, the driving recess 184 of the loading aid 150 is arranged in a protruding lug. In the exemplary embodiment, the driving pin 182 is arranged at the support 170 of the transfer axis 168 that is movable by the linear drive 180. Engagement or disengagement of the driving pin 182 with respect to the driving recess 184 typically requires a lifting movement (small in amount) along the lifting axis 162 when the loading aid 150 rests on a receiving space 144 of the feeding cart 140.

In exemplary embodiments, the support 170 of the transfer axis 168 further comprises a tilting axis 188. A slight tilting of the support 170 and a loading aid 150 arranged thereon around the tilting axis 188 is possible, if required. This allows the loading aid 150 and/or workpieces 176 to be provided in a preferred orientation. This can simplify the transfer of workpieces 176 to the handling unit 100 in the provisioning position 198.

FIG. 8 shows a side view (view orientation comparable to FIG. 6) of an interaction between the handling unit 100 and the provisioning unit 160. The handling unit 100 has a handling robot 102 that is guided on the top side 104 of the handling cell 70 (compare also FIG. 2). In exemplary embodiments, the handling robot 102 is arranged above the feeding cart 140 and above the provisioning unit 160, at least in a retracted state.

In exemplary embodiments, the handling robot 102 is configured to provide workpieces 176, if required, via a first loading interface 110 of a first machine tool 10 and/or via a second loading interface 112 of a second machine tool 10. This comprises an at least partial entry of the handling robot 102 into a respective workspace 24 of the machine tool 10. The first loading interface 110 and the second loading interface 112 are spaced apart from each other, compare also the schematic representation in FIG. 3.

To overcome the distance between the first loading interface 110 and the second loading interface 112, a positioning axis 192 is used along which the handling robot 102 is guided horizontally by a carriage 194. In the exemplary embodiment according to FIG. 8, the positioning axis 192 is parallel to the transfer axis 168. This is not to be understood in a limiting sense. The handling robot 102 can be moved along the positioning axis 192 to assume a favorable position with respect to the first loading interface 110 and the second loading interface 112. If only one loading interface 110 is provided, the positioning axis 192 can be omitted, if required.

The handling unit 100 is used to transfer workpieces 176 between the provisioning position 198 and the respective workpiece support 30 in the workspace 24 of the machine tool 10. This is done through a loading interface 110, 112 into the respective workspace 24. With reference to FIGS. 8 and 9, a tilting mechanism 200 is illustrated that enables tilting of the support 170 with loading aid 150 received thereon about the tilting axis 188. In FIG. 8, a tilted position of the support 170 is indicated by means of a dashed representation. The deliberate tilting of the support 170 allows the provision of workpieces 176 in a preferred orientation. This increases accuracy and simplifies gripping (or depositing) of workpieces 176 by a workpiece gripper of handling robot 102.

The support 170 is mounted on the lifting carriage 164 to be pivotable about the tilting axis 188. The tilting by the tilting mechanism 200 can be selectively brought about in the provisioning position 198. For this purpose, a holding piece 204 is provided, which is mounted on the frame side of the handling cell 70. The support 170 has a bearing piece 206 that can move into the holding piece 204, if required. In FIG. 9, the holding piece 204 and the bearing piece 206 are shown spaced apart for illustrative purposes. By way of example, the holding piece 204 has a groove 208 into which a roller 210 of the bearing piece 206 can engage. When the bearing piece 206 is engaged with the holding piece 204, the holding piece 204 retains the bearing piece 206 and consequently the support 170 when the lifting carriage 164 is moved further along the lifting axis 162. The tilted position of the support 170 indicated by dashed lines in FIG. 8 can be brought about if the lifting carriage 164 is lowered slightly along the lifting axis 162.

This causes tilting of the support 170 about the tilting axis 188, compare a curved double arrow 202 in FIGS. 8 and 9. FIG. 9 further illustrates an arrangement in which an actuator 216 is mounted to the support 170. The actuator 216 is configured to engage or disengage the bearing piece 206, if required, compare a double arrow 218 to illustrate the direction of movement. In this way, the roller 210 can move into the groove 208. In principle, it is also conceivable to dispense with the actuator 216. The bearing piece 206 can then be engaged in the holding piece 204, for example, by a defined movement of the support 170 along the transfer axis 168.

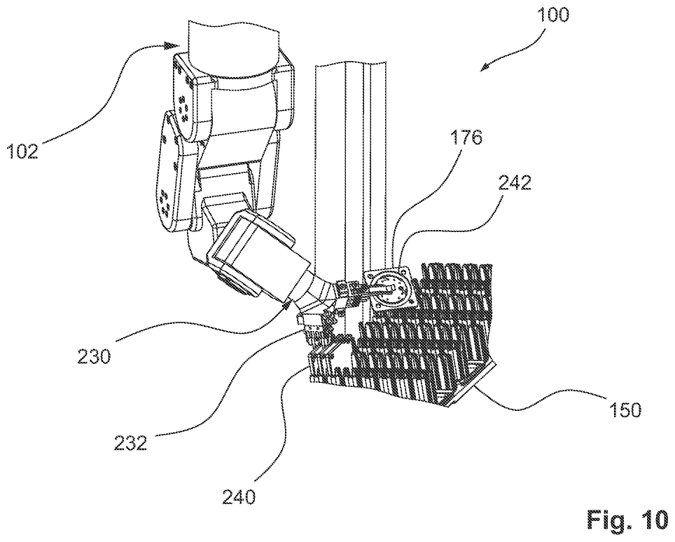

FIG. 10 illustrates an exemplary embodiment of the handling robot 102 of the handling unit 100 by means of a partial perspective view. In the exemplary embodiment, the handling robot 102 is arranged as an articulated robot. Other designs of the handling unit 100 are nevertheless conceivable. The handling robot 102 is a suspended robot. If required, a positioning axis 192 is provided on the ceiling side (or wall side) (compare FIG. 8).

For gripping or depositing workpieces, the handling robot 102 has an end effector in the form of a workpiece gripper 230. In the exemplary embodiment, the workpiece gripper 230 is arranged as a multiple gripper 232. In this way, the workpiece gripper 230 can pick up blanks 240 from the loading aid 150 and hand over machined workpieces 242 to the loading aid 150 without having to approach the workpiece holder 30 of the machine tool 10 in the meantime. The same applies to the workpiece exchange at the workpiece holder 30 in the workspace 24 of the machine tool 10. This reduces the workpiece exchange times.

What is claimed is:

1. A handling cell for a machine tool, comprising:
a loading interface that is arranged to be coupled to a workspace of a machine tool,
a handling unit with a handling robot,
a feeding interface for a feeding cart, and
a provisioning unit that is interposed between the handling unit and the feeding interface,
wherein the feeding cart is configured to transport workpieces that are arranged on loading aids, and
wherein the provisioning unit is configured to move the loading aids with the workpieces between the feeding cart and a provisioning position, where a transfer of workpieces between the provisioning unit and the handling unit takes place.

2. The handling cell of claim 1,
wherein the handling robot comprises a workpiece gripper and is configured to enter the workspace of the machine tool at least with the workpiece gripper through the loading interface in order to transfer a workpiece there between the workpiece holder and workpiece gripper.

3. The handling cell of claim 1,
wherein the loading aids are trays, and
wherein the handling robot is configured to transfer the workpieces between the trays that are provided at the provisioning position and the workspace of the machine tool.

4. The handling cell of claim 1,
wherein the handling robot is a suspended robot.

5. The handling cell of claim 1,
wherein the handling robot comprises a multiple gripper for handling multiple workpieces.

6. The handling cell of claim 1,
wherein the loading interface is a first loading interface, and
wherein a second loading interface is provided that faces away from the first loading interface and that is arranged to be coupled to a workspace of a second machine tool.

7. The handling cell of claim 6,
wherein the handling robot is movable along a positioning axis between the loading interface and the second loading interface, and
wherein the provisioning position is arranged along the travel path of the handling robot along the positioning axis between the loading interface and the second loading interface.

8. The handling cell of claim 7,
wherein the positioning axis is a horizontally oriented ceiling mounted positioning axis.

9. The handling cell of claim 7,
wherein the handling robot is guided above the feeding cart along the positioning axis during the movement between the loading interface and the second loading interface.

10. The handling cell of claim 1, further comprising:
a bay for the feeding cart, which is formed in an enclosure of the handling cell,
wherein a transfer of loading aids between the feeding cart and the provisioning position is enabled when the feeding cart entered the bay.

11. The handling cell of claim 10,
wherein the feeding cart comprises a movable securing element for securing received loading aids, and
wherein the securing element is mechanically unlocked upon the feeding cart entering the bay.

12. The handling cell of claim 1,
wherein the provisioning unit comprises a vertically oriented lifting axis and a horizontally oriented transfer axis with a support for at least one loading aid.

13. The handling cell of claim 12,
wherein the feeding cart has one or more receiving spaces for loading aids, which are arranged on top of each other in series,
wherein the transfer axis is arranged on a lifting carriage that is movable along the lifting axis, and
wherein the transfer axis comprises a linear drive for entering the feeding cart and removing or depositing loading aids at the one or more receiving spaces of the feeding cart.

14. The handling cell of claim 13,
wherein the lifting axis is adapted to generate lifting movements or depositing movements when the support is inserted along the transfer axis into the feeding cart to selectively lift or deposit loading aids from the receiving spaces.

15. The handling cell of claim 1,
wherein the provisioning unit further comprises a tilting mechanism that is configured to tilt loading aids to provide a transfer orientation for the workpieces in the loading aid.

16. The handling cell of claim 15,
wherein the tilting mechanism comprises a tilting axis, a frame-fixed holding piece that is spaced from the tilting axis, and a bearing piece that is arranged to engage the holding piece, and
wherein, with the bearing piece engaged in the holding piece, a lifting movement along the lifting axis enables tilting of the loading aid.

17. The handling cell of claim 1,
wherein an exchange of the feeding cart in the bay is enabled while a loading aid is provided by the provisioning unit at the provisioning position for transferring the workpieces.

18. A manufacturing system for machining workpieces, comprising:
at least one machine tool which is configured for multi-axis machining and has a tool holder and a workpiece holder, which are movable relative to one another in at least three axes,
wherein the tool holder and the workpiece holder are mounted on a rear side of a workspace of the machine tool, and
a handling cell, comprising:
a loading interface that is arranged to be coupled to a workspace of a first machine tool,
a handling unit with a handling robot,
a feeding interface for a feeding cart, and
a provisioning unit that is interposed between the handling unit and the feeding interface,
wherein the feeding cart is configured to transport workpieces that are arranged on loading aids, and
wherein the provisioning unit is configured to move the loading aids with the workpieces between the feeding cart and a provisioning position, where a transfer of workpieces between the provisioning unit and the handling unit takes place,
wherein the loading interface is laterally coupled to the workspace of the machine tool.

19. The manufacturing system of claim 18, further comprising:
at least a further machine tool which is arranged for multi-axis machining and has a tool holder and a workpiece holder, which are movable relative to one another in at least three axes,
wherein the tool holder and the workpiece holder are mounted on a rear side of a workspace of the machine tool,
wherein the loading interface of the handling cell is a first loading interface, and
wherein the handling cell comprises a second loading interface facing away from the first loading interface,
wherein the first loading interface is laterally coupled to the workspace of the first machine tool, and
wherein the second loading interface is laterally coupled to the workspace of the second machine tool.

20. The manufacturing system of claim 19,
wherein the first machine tool and the second machine tool each have a loading side that is arranged equally for the first machine tool and the second machine tool with respect to their respective workspaces, and
wherein the first machine tool and the second machine tool are coupled to the handling cell opposite each other and offset by 180° with respect to each other.
